(19) United States
(12) Patent Application Publication
(10) Pub. No.: US 2004/0105965 A1
(43) Pub. Date: Jun. 3, 2004

(54) Laminate nonwoven fabric exhibiting useful momentary crenulations

(76) Inventors: Imad Qashou, Cornelius, NC (US); Joseph F. Merker IV, Pittsgrove, NJ (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/618,291

(22) Filed: Jul. 11, 2003

Related U.S. Application Data
(60) Provisional application No. 60/398,804, filed on Jul. 26, 2002.

(51) Int. Cl. B32B 3/00

(52) U.S. Cl. 428/196

(57) ABSTRACT

The present invention relates to a cleaning laminate comprising two functionally diverse surfaces, wherein said first surface is formed from an abrasive nonwoven fabric layer, which facilitates the process of loosening particulates, such as dust and dirt, and said second surface is formed from an air permeable, absorbent nonwoven fabric layer, which exhibits a lower coefficient of friction as compared to the abrasive side. The abrasive nonwoven fabric layer is selected from such materials that provide a coarse quality, as perceived as a resistance to deflection.

### TECHNICAL FIELD

The present invention relates generally to a cleaning laminate, and specifically to a cleaning laminate comprising two functionally diverse surfaces, wherein said first surface is formed from an abrasive nonwoven fabric layer, which facilitates the process of loosening particulates, such as dust and dirt, and said second surface is formed from an air permeable, absorbent nonwoven fabric layer, which exhibits a lower coefficient of friction as compared to the abrasive side, wherein said abrasive nonwoven layer and said absorbent nonwoven layer are affixed in a bond pattern which allows for the nonwoven fabric layers to slip and distort against one another, thus inducing momentary performance-enhancing bunching or crenulations of the surfaces.

### BACKGROUND OF THE INVENTION

The general use of nonwoven fabrics as cleaning and cleansing articles is well known in the art. Various end-use articles are commercially available which utilize a combination of topical, performance enhancing additives and/or multi-layered laminate constructions. Enhanced versions of articles used in cleaning hard-surfaces further incorporate an optional cleaning fluid, including but not limited to, disinfectants, polishing solutions, and glass cleaners.

It has become desirable, by way of consumer convenience, to be able to utilize a single cleaning article for multiple tasks, wherein a single use wipe can abrade and/or disrupt a build up of dust or dirt, as well as, absorb or collect any resultant particulates and liquids. Past attempts have been made to construct a nonwoven, abrasive and absorbent hard surface cleaning laminate, such as described in U.S. Pat. No. 5,560,794 to Currie, et al., hereby incorporated by reference, wherein the layered abrasive and absorbent construct is comprised of three-dimensional conical protrusions, which taper into an aperture. The aforementioned apertures, however, only exist within the abrasive portion of the construct, limiting the amount of air that may flow through the entire construct.

The present invention contemplates a laminate wipe comprising first and second contact surfaces, wherein said first surface is comprised of an abrasive nonwoven fabric layer and said second surface is comprised of an absorbent, air permeable, nonwoven layer which exhibits a coefficient of friction less than said abrasive meltblown layer. The two different layers are affixed to one another in face-to-face juxtaposition such that distinct bonded and non-bonded or “pillow” regions are defined. Further, the invention efficiently integrates two separate cleaning articles into a single disposable cleaning article, thus promoting efficient manufacture, while obtaining the desired dual performance quality.

### SUMMARY OF THE INVENTION

The present invention relates to a cleaning laminate comprising two functionally diverse surfaces, wherein said first surface is formed from an abrasive nonwoven fabric layer, which facilitates the process of loosening particulates, such as dust and dirt, and said second surface is formed from an air permeable, absorbent nonwoven fabric layer, which exhibits a lower coefficient of friction as compared to the abrasive side. The abrasive nonwoven fabric layer is selected from such materials that provide a coarse quality, as perceived as a resistance to deflection. Representative abrasive materials include those having a highly crystalline fibrous component, fibrous components with a cross-sectional diameter of greater than about 25 micrometers, and the incorporation or application of deflection resistant chemical binders. Suitable absorbent nonwoven layers include those materials exhibiting a natural or chemically enhanced affinity for water.

The interaction between the absorbent nonwoven fabric layer and the abrasive nonwoven fabric layer includes two attributes so as to allow momentary crenulations to occur. First, the absorbent layer and the abrasive layer should exhibit at least a 10% difference in the coefficient of friction between the two layers. This difference in the coefficient of friction is believed to induce slip between the layers when a parallel shear force is applied, thus inducing “inter-layer” or “intra-laminate” abrasion, whereby the surface of the layers adopt a transitory bunching or wave pattern. Second, the nonwoven cleaning laminate is comprised of un-bonded or “pillow” regions having an abrasive layer to absorbent layer contact surface area of between about 0.5 square inches and 12 square inches. These pillow regions are essentially free from mechanical, chemical or thermal bonding, and thus allowing for the abrasive layer and the absorbent layer to shift and distort against one another, while maintaining a durable laminate construction.

When cleaning laminates formed in accordance with the present invention are employed in “wet” cleaning and cleansing applications, whereby the nonwoven cleaning laminate is exposed to a fluidic environment containing surfactants or soaps, the intra-laminate abrasion between the absorbent and abrasive layers, in conjunction with the air permeability of the absorbent layer, enables the laminate to work up a useful lather with reduced mechanical agitation. In “dry” cleaning applications, the ability of the absorbent and abrasive layers to shift against one another results in a momentary crenulation effect of the contact surfaces of the individual layers. This momentary crenulation or bunching of the layer in contact with the surface being cleaned significantly enhances the agitation performance of the abrasive layer.

It is within the purview of the present invention to optionally utilize specific additives or a combination of additives, so as to enhance the performance, visual appearance, or aromatic properties, wherein such additives are meant to include, but not limited to anti-microbial or disinfecting agents, pigments, and/or fragrances. Such enhancing agents may be provided in the form of a melt-additive in the polymer from which the abrasive nonwoven fabric layer and/or the absorbent nonwoven fabric layer is formed, or may comprise a post surface treatment applied to the laminate itself or deposited into a container or film packaging from which the end-use article may be dispensed.

Other features and advantages of the present invention will become readily apparent from the following detailed description, the accompanying drawings, and the appended claims.

### BRIEF DESCRIPTION OF THE DRAWINGS

The invention will be more easily understood by a detailed explanation of the invention including drawings. Accordingly, figures which are particularly suited for explaining the invention are attached herewith; however, is should be understood that such figures are for explanation purposes only and are not necessarily to scale. The figures are briefly described as follows:

FIG. 1 is a photomicrograph of the abrasive side of the nonwoven cleaning laminate in practicing the present invention;

FIG. 2 is a photomicrograph of the air permeable, absorbent side of the nonwoven cleaning laminate in practicing the present invention;

FIG. 3 is a photomicrograph on a macroscopic scale of the abrasive side of the nonwoven cleaning laminate in practicing the present invention; and

FIG. 4 is a photomicrograph on a macroscopic scale of the air permeable, absorbent side of the nonwoven cleaning laminate in practicing the present invention.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

The present invention relates to a cleaning laminate comprising two functionally diverse surfaces, wherein said first surface is formed from an abrasive nonwoven fabric layer, which facilitates the process of loosening particulates, such as dust and dirt, and said second surface is formed from an air permeable, absorbent nonwoven fabric layer, which exhibits a lower coefficient of friction as compared to the abrasive side. The abrasive nonwoven fabric layer is selected from such materials that provide a coarse quality, as perceived as a resistance to deflection. Representative abrasive materials include those having a highly crystalline fibrous component, fibrous components with a cross-sectional diameter of greater than about 25 micrometers, and the incorporation or application of deflection resistant chemical binders. Suitable absorbent nonwoven layers include those materials exhibiting a natural or chemically enhanced affinity for water.

The interaction between the absorbent nonwoven fabric layer and the abrasive nonwoven fabric layer includes two attributes so as to allow momentary crenulations to occur. First, the absorbent layer and the abrasive layer should exhibit at least a 10% difference in the coefficient of friction between the two layers. This difference in the coefficient of friction is believed to induce slip between the layers when a parallel shear force is applied, thus inducing “inter-layer” or “intra-laminate” abrasion, whereby the surface of the layers adopt a transitory bunching or wave pattern. Second, the nonwoven cleaning laminate is comprised of un-bonded or “pillow” regions having an abrasive layer to absorbent layer contact surface area of between about 0.5 square inches and 12 square inches. These pillow regions are essentially free from mechanical, chemical or thermal bonding, and thus allowing for the abrasive layer and the absorbent layer to shift and distort against one another, while maintaining a durable laminate construction.

Technologies capable of forming nonwoven fabrics layers suitable for application in the present invention include those which form continuous filament nonwoven fabrics, staple fiber nonwoven fabrics, and the combinations thereof. The abrasive nonwoven fabric layer is selected from such nonwoven forming technologies that provide a coarse quality, as perceived as a resistance to deflection. Representative abrasive materials include those having a highly crystalline fibrous component, fibrous components with a cross-sectional diameter of greater than about 25 micrometers, and the incorporation or application of deflection resistant chemical binders. Suitable absorbent nonwoven layers include those materials exhibiting a natural or chemically enhanced affinity for water.

Fibers and/or filaments comprising the nonwoven fabric layers are selected from natural or synthetic composition, of homogeneous or mixed fiber length. Suitable natural fibers include, but are not limited to, cotton, wood pulp and viscose rayon. Synthetic fibers, which may be blended in whole or part, include thermoplastic and thermoset polymers. Thermoplastic polymers suitable for blending with thermoplastic resins include polyolefins, polyamides and polyesters. The thermoplastic polymers may be further selected from homopolymers; copolymers, conjugates and other derivatives including those thermoplastic polymers having incorporated melt additives or surface-active agents.

In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

A related means to the spunbond process for forming a layer of a nonwoven fabric is the melt blown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203, incorporated herein by reference.

Staple fibers used to form nonwoven fabrics begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric desired. The fibrous batt is integrated into a nonwoven fabric by application of suitable bonding means, including, but not limited to, use of chemical binders, thermobonding by calender or through-air oven, and hydroentanglement.

The joined regions of the nonwoven cleaning laminate may be formed by continuous or discontinuous bonds, and induced by chemical, thermal and mechanical means.

### EXAMPLE

A nonwoven cleaning laminate was formed in accordance with the present invention comprising an abrasive layer formed from a nonwoven fabric comprising coarse denier meltblown filaments and an absorbent layer formed from a nonwoven fabric comprising carded, through air bonded staple fibers.

The coarse denier meltblown filaments where spun from a spunbond resin extruded through a conventional meltblown process so as to capture thicker filaments. Utilizing a spunbond resin with a lower melt flow rate, as well as lowering the attenuation air pressure allows the collected filaments to take on a thicker diameter, providing the overall collective web with a desirable coarse texture.

A polypropylene spunbond resin, commercially known as PP3155 made available by Exxon Chemical Company was utilized. The aforementioned resin had a 35 MFR and was extruded at an average die temperature of 562° Fahrenheit with an approximate throughput of 7.1 grams/hole/min. Further, the distance between the meltblown die and the collective surface was approximately 19 inches. The resultant meltblown filaments exhibit an average denier of greater than about 25 micrometers. The resulting self-annealing meltblown filaments were collected as an approximate 1.0 ounce per square yard nonwoven fabric.

The absorbent layer comprised an approximate 2.0 ounce per square yard carded, through-air bonded staple fiber nonwoven fabric. The staple fibers used included 18 micrometer diameter by 1.5 inch staple length polypropylene.

The two different nonwoven layers were placed in face-to-face juxtaposition and subsequently subjected to thermal bonding by application of ultrasonic energy. The ultrasonic bond pattern used to join the abrasive layer and the absorbent layer to form a plurality of approximately 2.0 square inch un-bonded or “pillow” regions in the laminate.

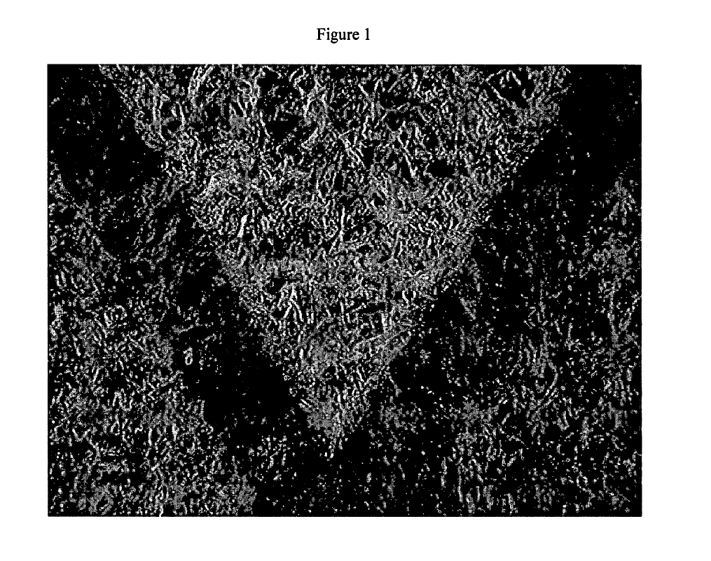

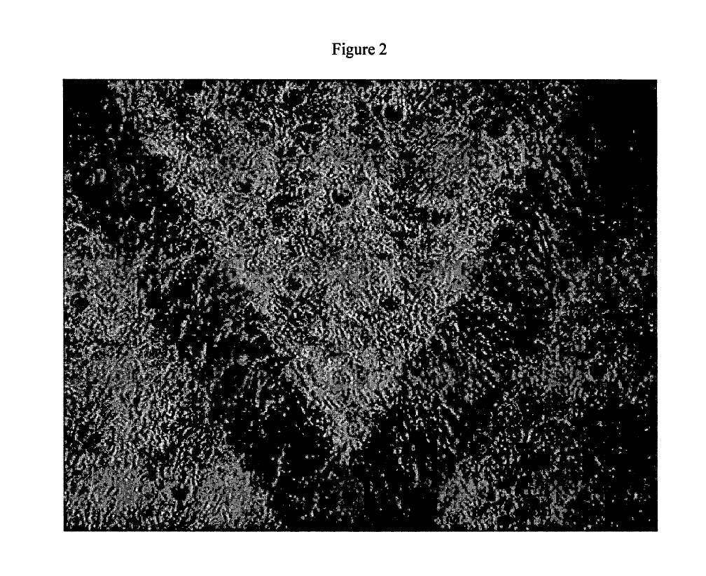

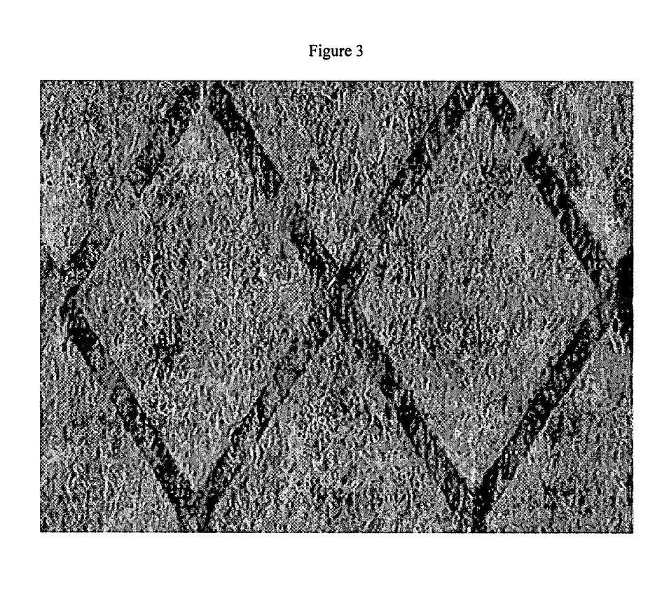

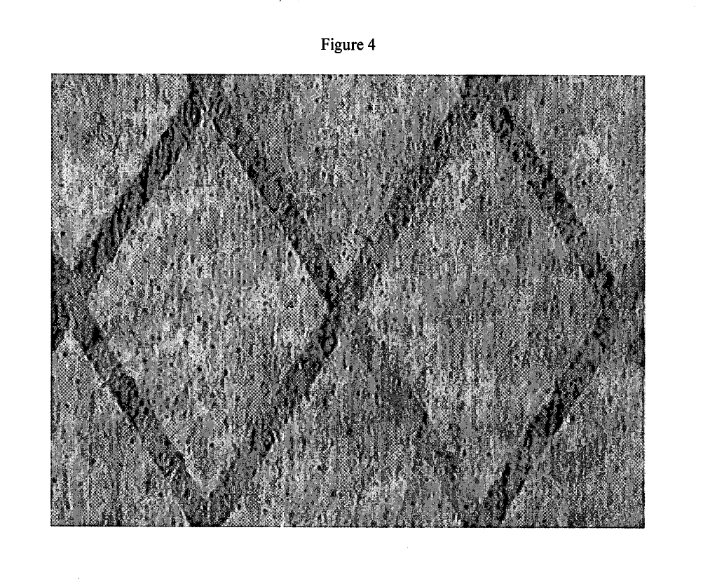

FIGS. 1 through 4 depict the material formed in accordance with this example.

When cleaning laminates formed in accordance with the present invention are employed in “wet” cleaning and cleansing applications, whereby the nonwoven cleaning laminate is exposed to a fluidic environment containing surfactants or soaps, the intra-laminate abrasion between the absorbent and abrasive layers, in conjunction with the air permeability of the absorbent layer, enables the laminate to work up a useful lather with reduced mechanical agitation. In “dry” cleaning applications, the ability of the absorbent and abrasive layers to shift against one another results in a momentary crenulation effect of the contact surfaces of the individual layers. This momentary crenulation or bunching of the layer in contact with the surface being cleaned significantly enhances the agitation performance of the abrasive layer.

It is within the purview of the present invention to optionally utilize specific additives or a combination of additives, so as to enhance the performance, visual appearance, or aromatic properties, wherein such additives are meant to include, but not limited to anti-microbial or disinfecting agents, pigments, and/or fragrances. Such enhancing agents may be provided in the form of a melt-additive in the polymer from which the abrasive nonwoven fabric layer and/or the absorbent nonwoven fabric layer is formed, or may comprise a post surface treatment applied to the laminate itself or deposited into a container or film packaging from which the end-use article may be dispensed.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A nonwoven cleaning laminate, comprising:
a. an abrasive nonwoven fabric layer;
b. an absorbent nonwoven fabric layer, wherein said absorbent nonwoven fabric layer exhibits a difference in coefficient of friction of at least 10% as compared to the abrasive layer;
c. wherein said abrasive nonwoven fabric layer and said absorbent nonwoven fabric layer are joined together in a face to face juxtaposition so as to exhibit regions in the laminate that are bonded and un-bonded; and
d. wherein said un-bonded regions have an abrasive nonwoven fabric layer to absorbent nonwoven fabric layer contact surface area of between about 0.5 square inches and 12 square inches.
